(19) United States
(12) Patent Application Publication
(10) Pub. No.: US 2007/0273517 A1
(43) Pub. Date: Nov. 29, 2007

(54) Apparatus and method for integrated healthcare management

(76) Inventor: Navin Govind, Carlsbad, CA (US)

Correspondence Address: WRIGHT LAW GROUP, PLLC, 7201 WEST OAKLAND, SUITE 2, CHANDLER, AZ, 85226, US

(21) Appl. No.: 11/441,658

(22) Filed: May 26, 2006

(51) Int. Cl. G08B 13/14; G06F 19/00; G06F 17/00

(52) U.S. Cl. 340/572.1; 705/3; 235/375

(57) ABSTRACT

The apparatus and methods disclosed herein implement a convenient and efficient standards based healthcare management system. The various preferred embodiments of the present invention enable the healthcare industry to deliver efficient, low cost and higher quality services through value added RFID technology and information processing solutions. The most preferred embodiments of the present invention enable the tracking of medical assets, processing of portable electronic patient health information, and provides a robust web-enabled interface for monitoring and managing interoperable healthcare information. The three main components of the present invention are the Asset Management component, the Personal Health Manager component, and the Clinical Information Management component. These components, taken together, offer a standards-based modular, platform for delivering efficient and effective healthcare management solutions.

### BACKGROUND OF THE INVENTION

1. Field of the Invention

The present invention relates generally to the field of health care and more specifically relates to the use of specialized integrated hardware and software systems to enhance the management and delivery of health care services in an enterprise healthcare environment.

2. Background Art

Providing healthcare for the population of the world is an important but increasingly complex and expensive proposition. The growth of the senior citizen segment, coupled with the advanced treatments now available for many illnesses and injuries have combined to lengthen the average lifespan and, correspondingly, increase the demand and cost of providing healthcare across most segments of society. While the provision of healthcare services is a significant function of every society, the presently known methodologies and standards are generally viewed as less than optimal in certain respects. For example, there are a wide variety of disparate, relatively heterogeneous, fragmented, and proprietary healthcare related applications, software services, systems and hardware platforms in use today. These various systems and applications are used to process a wide variety of data in multiple disparate formats with proprietary solutions. This includes applications for clinicians maintaining patient health record in paper and electronic form.

In addition to, and at least partially fueled by, the logistical difficulties associated with providing healthcare, the costs of providing healthcare in the U.S. continues to soar with healthcare expenditures now amounting to approximately $1.8 trillion annually, or about $6,300 per person per year, accounting for approximately 15.8% of gross domestic product (GDP). This high cost is expected to grow to more than $2.75 trillion by 2010. To address the growing burden of healthcare cost, patient safety, and level of care in the U.S., the President of the United States signed an executive order in 2004 creating the position of the Office of the National Coordinator for Health Information Technology (ONCHIT) within the Department of Health and Human Services.

At least a portion of the problem with the delivery of healthcare is the relative dearth of technology in the overall process. While state-of-the-art equipment may now be available for performing many medical procedures and treatments, many routine yet critical healthcare management operations and functions are still highly dependant on decades old technology, making the healthcare industry one of the last to realize the full potential of global IT to increase productivity and compete cost-effectively. A recent study showed that clinical information is frequently unavailable in primary care, and that this missing information can be harmful to patients. The study also showed that clinical information was less likely to be missing in practices that had electronic health records. This adds to the substantial evidence that “health IT,” including computer-physician order entry, ePrescribing, preventative reminders, and bar code scanning to name a few, can improve care, reduce wasteful and redundant treatments, and prevent medical errors.

The National Health Information Network initiative, under the auspices of ONCHIT, outlined the nationwide implementation of interoperable health information technology across the industry. The initiative recommends the need for using identification technology to meet key goals such as portable electronic patient records, interoperable clinical information and medical asset tracking to increase patient safety to name a few.

While some tentative steps have been taken towards the vision of integrated information technology for healthcare, numerous issues need to be addressed in order to make this vision a reality. Specifically, existing technology and health management standards will need to be used and new standards developed to ensure interoperability, security and portability across applications and platforms in a wide variety of settings. One such evolving technology standard that has seen some limited application in the healthcare arena is Radio Frequency Identification (RFID).

Basically, RFID is a method of identifying unique items using radio waves that complements and enhances bar code identification technology. RFID systems generally consist of three key components. The first component, “Tag,” is a microchip or similar device that contains a unique digital serial number and is attached to an antenna. Next is the “Reader,” a device used to communicate with one or more RFID tags to read tag-related data. Finally, there is a “Software” component that processes, routes and manages Tag data and Readers. RFID systems are generally used to identify, track and manage assets by first tagging objects, such as products and pallets, and then by reading the tag data with one or more Readers and processing the results using the Software. Current RFID tags have the capability to hold data that can amount to over 60 billion items. In cases where the tag data has to be read multiple times, several terabytes of data may be generated on the network. This RFID generated data is several orders in magnitude compared to existing data present in the network that needs to be processed at several stages within the network. The RFID data then needs to be analyzed, secured, filtered and presented dynamically by multiple systems in a relevant manner.

RFID as an auto identification technology has been around for several decades. More recently, due to mandates from industry leading retailers and government agencies, RFID systems are being deployed at a fast rate to reduce inventory losses, increase on-shelf product visibility and lower overall supply chain costs. Increased investment in RFID technology has brought retailers such as Wal-Mart, Tesco, etc. closer to the goal of item level visibility today than two years ago. The U.S. Department of Defense, with perhaps the most intricate global supply chain system, has deployed RFID as an enabler to its vision of an integrated supply chain. The DoD has claimed its RFID systems have increased reliability, improved visibility of assets throughout the supply chain, improved process efficiency and secured customer confidence.

Specifically in the healthcare industry, broader use of RFID can solve several business problems. The healthcare industry is experiencing inefficient medical supply management due to multiple proprietary systems and a lack of technology standards. Use of paper forms adds to significant patient and medication administration errors in hospitals. Instant availability of critical clinical information that can increase patient safety and care quality largely remains a persistent problem that needs to be solved. These problems contribute directly to care delivery costs rising exponentially, impact patient safety and reduce overall care quality.

Similarly, supply costs represent approximately one third of a hospital's cost structure. Inefficiencies in business processes and lack of real time information from disparate applications deployed amongst suppliers, payees and payers account for a majority of this cost. Many hospitals can benefit from improved patient care and lower costs by deploying standards based interoperable RFID clinical information processing solutions to track and manage assets real time.

Another healthcare application for RFID technology is the management of patient care. It is estimated that preventable medical errors in the U.S. cause between 44,000 and 98,000 deaths and cost $17 billion yearly. Hospitals have piloted the use of patient RFID wrist-bands to improve patient administration and access patient records to deliver quality healthcare. This is one of the most promising uses of RFID with the benefit of not only delivering high quality healthcare but also improving business processes to lower cost by integrating back-end services for disease management, drug disposal and billing.

RFID use in the Healthcare industry has gained traction as a means to address the U.S. Food and Drug Administration mandate to track regulated prescription drugs. In February 2005 the FDA mandated the use of bar codes on drugs dispensed in hospitals to reduce medical errors and increase patient safety from adverse drug effects. It is estimated that non-compliance with medication i.e. dispensing of contraindicated medicine in the U.S. causes 125,000 deaths yearly, 11 percent of hospital admissions and costs $100 billion yearly. The immediate benefit of the FDA mandate is clear. Its adoption helped reduce medication error rates by as much as 85% at some test-bed hospitals, but, more is needed to enable real time tracking and recording of drugs in an automated fashion.

While tracking pharmaceuticals is one application for RFID, hospital investment in this technology can be further leveraged to address the need for tracking and managing expensive medical assets. Studies have shown that more than $11 billion wasted in the years 2003 and 2004 on inefficiencies relating to hospital supply spending. Locating, identifying and verifying expensive medical equipment, lowering thefts and more importantly, maximizing the use of life saving equipment such as an ECG/EKG is critical to addressing this opportunity.

Given the well-documented problems in the current system of healthcare delivery, providing improved more efficient access to healthcare services remains largely an unsolved problem. Doctors remain frustrated by unnatural administrative bottlenecks and bureaucratic constraints that hamper their ability to deliver quality healthcare to their patients. Patients bemoan the restrictions on access to healthcare providers, the lack of quality treatment, and the high cost of receiving healthcare. Insurance companies and other entities related to the financing of healthcare delivery constantly struggle to control costs. Accordingly, without developing improved systems and methodologies for simplifying and streamlining the management of equipment, data, processes and methodology for the delivery of healthcare services, the entire healthcare system will continue to be sub-optimal for all entities involved in the process.

### SUMMARY OF THE INVENTION

The apparatus and methods disclosed herein implement a convenient and efficient standards based healthcare management system. The various preferred embodiments of the present invention enable the healthcare industry to deliver efficient, low cost and higher quality services through value added RFID technology and information processing solutions. The most preferred embodiments of the present invention enable the tracking of medical assets, processing of portable electronic patient health information, and provides a robust web-enabled interface for monitoring and managing interoperable healthcare information. The three main components of the present invention are the Asset Management component, the Personal Health Manager component, and the Clinical Information Management component. These components, taken together, offer a standards-based modular, platform for delivering efficient and effective healthcare management solutions.

### BRIEF DESCRIPTION OF THE DRAWINGS

The preferred embodiments of the present invention will hereinafter be described in conjunction with the appended wherein like designations denote like elements and:

FIG. 1 is a block diagram of a computer system and related components for implementing an integrated healthcare management system in accordance with a preferred exemplary embodiment of the present invention;

FIG. 2 is a block diagram of a data server used for implementing an integrated healthcare management system in accordance with a preferred exemplary embodiment of the present invention;

FIG. 3 a block diagram of an architectural structure for deploying an integrated healthcare management system in accordance with a preferred embodiment of the present invention;

FIG. 4 is a block diagram of the middleware services and management modules for deploying an integrated healthcare management system in accordance with a preferred exemplary embodiment of the present invention;

FIG. 5 is a block diagram for the structure of a healthcare-specific XML language in accordance with a preferred exemplary embodiment of the present invention;

FIG. 6 is a schematic representation for an XML-based structure/schema in accordance with a preferred embodiment of the present invention;

FIG. 7 is a schematic representation of a user interface for viewing records maintained by an integrated healthcare management system in accordance with a preferred exemplary embodiment of the present invention;

FIG. 8 is a flow chart for a method of using RFID tags in an integrated healthcare management system in accordance with a preferred exemplary embodiment of the present invention;

FIG. 9 is a flow chart for a method of using RFID tags to manage assets in an integrated healthcare management system in accordance with a preferred exemplary embodiment of the present invention; and

FIG. 10 is a flow chart for a method of using RFID tags to manage healthcare records in an integrated healthcare management system in accordance with a preferred exemplary embodiment of the present invention.

### DETAILED DESCRIPTION

The apparatus and methods disclosed herein implement a convenient and efficient standards based healthcare management system. The various preferred embodiments of the present invention enable the healthcare industry to deliver efficient, low cost and higher quality services through value added RFID technology and information processing solutions. The most preferred embodiments of the present invention enable the tracking of medical assets, processing of portable electronic patient health information, and provides a robust web-enabled interface for monitoring and managing interoperable healthcare information. The three main components of the present invention are the Asset Management component, the Personal Health Manager component, and the Clinical Information Management component. These components, taken together, offer a standards-based modular, platform for delivering efficient and effective healthcare management solutions.

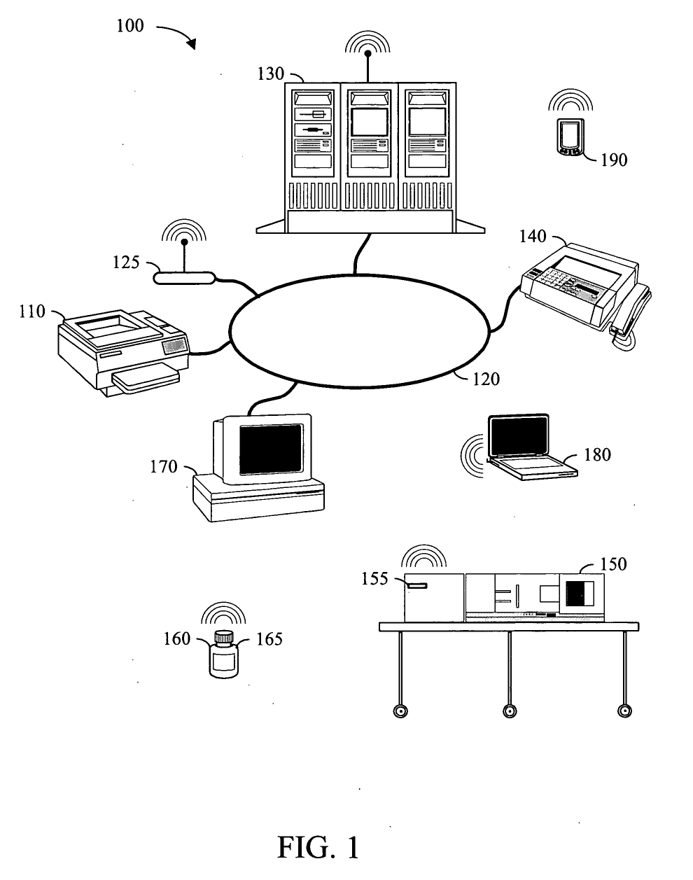

Referring now to FIG. 1, an RFID-enabled, integrated healthcare management system 100 in accordance with a preferred embodiment of the present invention comprises: at least one RFID reader 125; a data server 130; at least one RFID tag 155; a desktop computer 170; a laptop computer 180, and a personal digital assistant 190; all connected or coupled via a network 120. Additionally, medical equipment 150, medication 160, an optional printer 110, and an optional fax machine 140 are shown.

Taken together, the components of integrated healthcare management system 100 provide a way for a disparate user base, including doctors, nurses, administrators, and patients, to access one or more components or subsystems of integrated healthcare management system 100 as described herein in conjunction with the various preferred embodiments of the present invention. While the present invention will be described in detail by using the example of a typical health clinic or hospital application, those skilled in the art will recognize that the methods and techniques described herein have broad applicability to other environments and applications where secure and efficient access to healthcare management information is desirable.

Network 120 is any suitable computer communication link or communication mechanism, including a hardwired connection, an internal or external bus, a connection for telephone access via a modem, standard co-axial cable lines, high-speed T1 line, radio, infrared or other wireless communication methodologies (i.e. “Bluetooth,” infrared (IR), etc.), private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link. Other communication technologies may also be deployed including UWB, wireless Universal Serial Bus (USB), Wi-Fi and WiMAX.

In the most preferred embodiments of the present invention, at least a portion of network 120 comprises a standard Internet connection between the various components of integrated healthcare management system 100. Network 120 provides for communication between the various components of integrated healthcare management system 100 and allows for relevant information to be transmitted from device to device. In this fashion, a user of integrated healthcare management system 100 can quickly and easily gain access to the relevant data and information utilized to search, retrieve, and display information from one or more databases as described in conjunction with the preferred embodiments of the present invention. Regardless of physical nature and topology, network 120 serves to logically link the physical components of integrated healthcare management system 100 together, regardless of their physical proximity, thereby enabling communication between the components. This is especially important because in many preferred embodiments of the present invention, data server 130, desktop computer 170, and laptop computer 180 may be geographically remote and/or physically separated from each other.

RFID reader 125 represents one or more multi-protocol RFID readers that are each capable of capturing, decoding, and transmitting RFID signals. In the most preferred embodiments of the present invention, RFID reader 125 is capable of communication using Class 0, Class 1, Class 2, and EPCglobal Architecture Framework protocols, among others. The exact number and placement of RFID readers 125 will be based on the specific application and related logistical factors such as the area of RFID coverage desired, number of devices to be tracked via RFID, etc. Regardless of the actual number or location where deployed, one or more RFID readers 125 will be used to provide tracking and location information for integrated healthcare management system 100.

Data server 130 represents a relatively powerful computer system that is made available to desktop computer 170 and laptop computer 180 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 130. Data server 130 may also provide various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 130 may be provided by many standard, readily available data servers. This may also include the deployment of multiple inter-connected data servers 130 to enhance the availability and reliability of the functions provided by data server 130. Depending on the desired size and relative power required for data server 130, storage area network (SAN) technology may also be deployed in certain preferred embodiments of the present invention. Additionally, various biometric and identification verification devices for creating and verifying digital signatures (i.e., electronic signature processing) may also be included.

Medical equipment 150 is representative of the many types of medical equipment that may be used or deployed in any type of healthcare environment. For example, capital equipment such as CAT scan machines, sonography machines, defibrillators, etc. are but a few examples of the types of medical equipment that may be represented by medical equipment 150. In the most preferred embodiments of the present invention, medical equipment 150 is equipped with an RFID tag 155. RFID tag 155 is any type of RFID tag known to those skilled in art. This includes passive or active RFID tags.

Additionally, RFID tag 155 may employ any RFID protocol known to those skilled in the art. The purpose of RFID tag 155 is to allow for the tracking, reporting and general management of medical equipment 150. In the most preferred embodiments of the present invention, each different piece of medical equipment 150 will have its own RFID tag 155. RFID tag 155 will contain information about medical equipment 150 and the information contained in each RFID tag 155 will be capable of being read by RFID readers 125.

As medical equipment 150 is transported from location to location within the range of RFID readers 125, the movement and duration of stay for medical equipment 150 can be tracked by RFID readers 125 and reported back to for use by other components of integrated healthcare management system 100. Similarly, the use of an RFID tag in conjunction with a patient, doctor, nurse, administrator, etc. and facilitate tracking and locating persons within a healthcare facility. In this case, part of the data read by RFID readers 125 will include an identification code or other data element that can be used to identify the person associated with the RFID tag.

The information generated by RFID tags 155 and 165 can be used by integrated healthcare management system 100 to generate visual representations, schematics, and maps of the healthcare facility and to thereby verify the location of medical equipment 150 for the users of integrated healthcare management system 100. The graphics can be rendered by Simple Vector Graphics (SVG) or other suitable technology and then displayed for users of desktop computer 170 and laptop computer 180.

Medication 160 is representative of any type of medication that may be used or deployed in any type of healthcare environment. For example, medication that has been prescribed for a patient to take home after treatment may be represented by medication 160. Similarly, medication that is kept in a healthcare facility for use in treating patients onsite may also be represented by medication 160. Medication 160 may be a topical treatment or some type of medication that is designed to be ingested or injected. In some instances, medication 160 will be a controlled substance where the careful monitoring of the controlled substance is mandated by law.

Regardless of the form or formulation, quantity, or application, medication 160 is generally used in conjunction with patient care. In at least some preferred embodiments of the present invention, the container for medication 160 will be equipped with an RFID tag 165, thereby enabling the tracking of medication 160 by integrated healthcare management system 100 of FIG. 1. As with medical equipment 150, the location and movement of medication 160 will be tracked and reported by one or more RFID readers 125 and this information will be made available to other components of integrated healthcare management system 100. Those skilled in the art will recognize that other items, such as medical supplies, could also be handled in the same way.

Desktop computer 170 may be any type of computer system known to those skilled in the art that is capable of being configured for use with integrated healthcare management system 100 as described herein. This includes various levels of desktop computers, tablet computers, pen-based computers and the like. Additionally, handheld and palmtop devices are also specifically included within the description of devices that may be deployed as a computer system 170. It should be noted that no specific operating system or hardware platform is excluded and it is anticipated that many different hardware and software platforms may be configured to create computer system 170. As previously explained in conjunction with data server 130, various hardware components and software components (not shown this FIG.) known to those skilled in the art may be used in conjunction with computer system 170. It should be noted that in the most preferred embodiments of the present invention, desktop computer 170 is linked (via wired or wireless connection) to its own LAN or WAN and has access to its own data server (not shown this FIG.).

Similarly, laptop computer 180 may be any type of relatively lightweight portable computer system known to those skilled in the art that is capable of being configured for use with integrated healthcare management system 100 as described herein. This includes tablet computers, pen-based computers and the like. Additionally, handheld and palmtop devices are also specifically included within the description of devices that may be deployed as a laptop computer 180. It should be noted that no specific operating system or hardware platform is excluded and it is anticipated that many different hardware and software platforms may be configured to create laptop computer 180. As previously explained in conjunction with data server 130, various hardware and software components (not shown this FIG.) known to those skilled in the art may be used in conjunction with laptop computer 180. It should also be noted that in the most preferred embodiments of the present invention, laptop computer 180 is linked to its own LAN or WAN and has access to its own data server (not shown this FIG.).

In general, the communication between devices associated with data server 130 will be requests for entering date into or retrieving data from one or more databases located on data server 130. The users of desktop computer 170 and/or laptop computer 180 may be healthcare practitioners such as doctors or nurses. Additionally, various related service providers such as insurance companies and employers may also have access to one or more databases located on data server 130 via desktop computer 170 and/or laptop computer 180. A typical transaction may be represented by a request for retrieving the medical history for a patient. In this case, a request to access a patient's medical history is sent from desktop computer 170 and/or laptop computer 180 to data server 130.

Upon receipt of a valid request, data server 130 processes the request to access one or more databases containing the relevant information and takes the specific action requested by desktop computer 170 and/or laptop computer 180, typically by retrieving and returning the requested data to desktop computer 170 and/or laptop computer 180. The request may be directed towards locating a specific item in a database, comparing one or more items in the database, obtaining additional information from a database about one or more patients, or other similar requests.

It should be noted that while FIG. 1 shows only a single desktop computer 170 and a single laptop computer 180, it is anticipated that the most preferred embodiments of the present invention will comprise hundreds and even thousands of computer systems 170 and laptop computers 180. Each of these computers 170 and 180 will be configured to access data server 130 in an appropriately secure way so as to accomplish the specific objectives of the user of the desktop computer 170 or laptop computer 180. For example, the service provider that controls the databases stored on data server 130 may utilize desktop computer 170 or laptop computer 180 to access data server 130 and create or modify a given database. An insurance provider, located in a remote location, may use desktop computer 170 or laptop computer 180 to access data server 130 to retrieve information about medical treatments provided for an insured patient that are stored in a database stored on data server 130, etc.

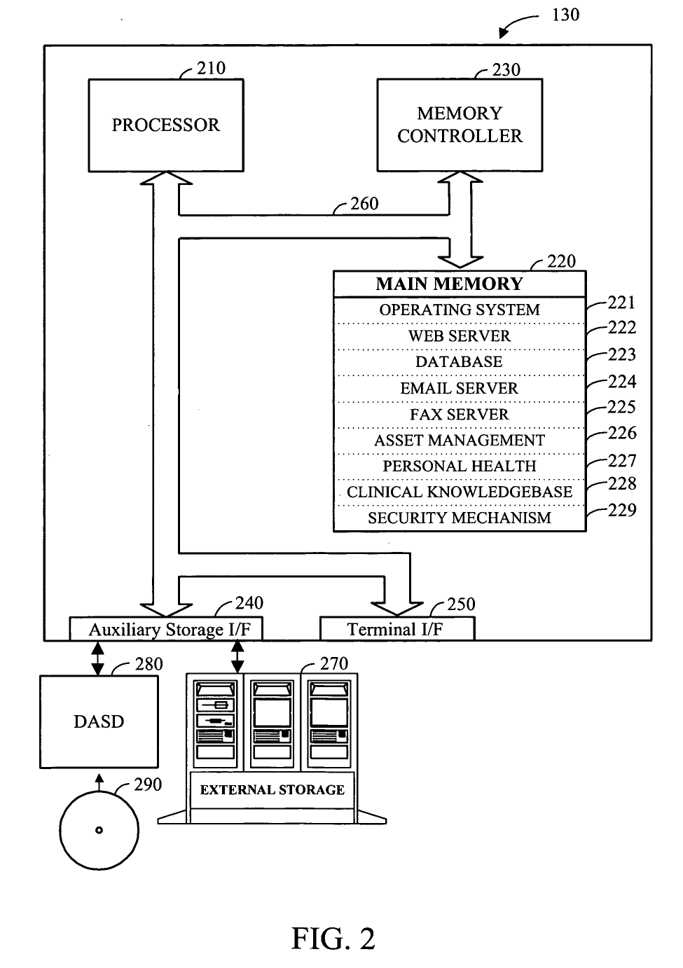

In the most preferred embodiments of the present invention, multiple desktop computers 170 and multiple laptop computers 180 will all be configured to communicate simultaneously with data server 130 and with each other via network 120. In addition, the most preferred embodiments of the present invention include an Application Service Provider (ASP) environment where data server 130 is operated as a clearinghouse in a hosted operation. In this fashion, multiple desktop computers 170 and laptop computers 180 will have access to data server 130 and the databases stored thereon via a global computer network such as the Internet. Data server 130 is further described below in conjunction with FIG. 2 below.

Optional printer 110 and an optional fax machine 140 are standard peripheral devices that may be used for transmitting or outputting paper-based documents, notes, transaction details, reports, etc. in conjunction with the various requests and transactions processed by integrated healthcare management system 100. Optional printer 110 and an optional fax machine 140 may be directly connected to network 120 or indirectly connected to network 120 via any or all of desktop computers 170, laptop computers 180, and/or data server 130. Finally, it should be noted that optional printer 110 and optional fax machine 140 are merely representative of the many types of peripherals that may be utilized in conjunction with integrated healthcare management system 100. It is anticipated that other similar peripheral devices will be deployed in the various preferred embodiment of the present invention and no such device is excluded by its omission in FIG. 1.

Those skilled in the art will recognize that FIG. 1 depicts a fairly standard “client/server” type communication arrangement where data server 130 is considered to be a server and computers 170 and 180 are considered to be clients of data server 130. Additionally, those skilled in the art will recognize that the functionality of data server 130 may be deployed on either of computers systems 170 and 180 in a more traditional “stand-alone” environment. In either case, the methods of the present invention are designed to minimize the amount of data that must be transferred from a database to the user of integrated healthcare management system 100.

Personal digital assistant (PDA) 190 is representative of a class of devices that are at least somewhat less full-featured and less powerful than computers 170 and 180. This includes, for example, Palm OS devices, Pocket PC devices, and various types of “smart phones” for example. Those skilled in the art will recognize these various devices and others that are suitable for deployment as PDA 190. While somewhat less powerful than computers 170 and 180, PDA 190 is also configured to communicate with data server 130 via network 120 to send and retrieve healthcare-related information to and from data server 130. Given the standard functionality for devices that may be deployed as PDA 190, this communication will typically be a wireless Internet connection or a Bluetooth connection. One example of the use for PDA 190 in the context of integrated healthcare management system 100 would be a doctor making rounds and entering updated patient status information into a patient's medical record stored in a database on data server 130. Those skilled in the art will recognize that “smart” handhelds and tablet computers are other devices that are also capable of processing several types of wireless input such as biometric, speech, handwriting in addition to mouse and keyboard.

Referring now to FIG. 2, data server 130 of FIG. 1 in accordance with a preferred embodiment of the present invention represents one of many commercially available computer systems such as a Linux-based computer system, an IBM compatible computer system, or a Macintosh computer system. However, those skilled in the art will appreciate that the methods and apparatus of the present invention apply equally to any computer system, regardless of the specific operating system and regardless of whether the computer system is a traditional “mainframe” computer, a complicated multi-user computing apparatus or a single user device such as a personal computer or workstation.

Data server 130 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 130 illustrated in FIG. 2 within the scope of the present invention such as the addition of cache memory or other peripheral devices. FIG. 2 is not intended to be exhaustive, but is presented to simply illustrate some of the more salient features of data server 130.

Processor 210 performs computation and control functions of data server 130, and most preferably comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor or CPU. Processor 210 suitably executes one or more software programs contained within main memory 220.

Auxiliary storage interface 240 allows data server 130 to store and retrieve information from auxiliary storage devices, such as external storage mechanism 270, magnetic disk drives (e.g., hard disks or floppy diskettes) or optical storage devices (e.g., CD-ROM). One suitable storage device is a direct access storage device (DASD) 280. As shown in FIG. 2, DASD 280 may be a DVD or CD-ROM drive that may read programs and data from a DVD or CD disk 290.

It is important to note that while the present invention has been (and will continue to be) described in the context of a fully functional computer system with certain application software, those skilled in the art will appreciate that the various software mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as DVD and CD ROMS disks (e.g., disk 290), and transmission type media such as digital and analog communication links, including wireless communication links.

Various preferred embodiments of the program product may be configured to: create and modify multiple databases; track, update and store healthcare information for a plurality of patients, healthcare providers, and healthcare facilities; configure and implement various search and retrieve functions for a multitude of search requests made by users of the system; track and store information about various physical assets; provide access to healthcare-related information and research; update and transmit search results to one or more users; and provide one or more user interfaces for accomplishing all of these functions. In this fashion, the appropriate entities (i.e., doctors, patients, insurance providers, administrators, etc.) can utilize the program product to initiate and complete a wide variety of database-related applications. Similarly, a program product in accordance with one or more preferred embodiments of the present invention can also be configured to perform substantially all of the steps depicted and described in conjunction with the figures below for implementing a fully integrated healthcare management system.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 130, normally through separate workstations or through stand-alone computer systems such as computer systems 170 and computer systems 180 of FIG. 1. Although data server 130 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, a database 223, an email server 224, a fax server 225, an asset management mechanism 226, a personal health management mechanism 227, a clinical knowledgebase 228 and a security mechanism 229. Asset management mechanism 226, personal health management mechanism 227, and clinical knowledgebase 228 rules also comprise a rules engine and work flow model to assist with the overall flow of data storage and retrieval. The term “memory” as used herein refers to any storage location in the virtual memory space of data server 130.

It should be understood that main memory 220 might not necessarily contain all parts of all components shown. For example, portions of operating system 221 may be loaded into an instruction cache (not shown) for processor 210 to execute, while other files may well be stored on magnetic or optical disk storage devices (not shown). In addition, although database 223 is shown to reside in the same memory location as operating system 221, it is to be understood that main memory 220 may consist of multiple disparate memory locations. It should also be noted that any and all of the individual components shown in main memory 220 might be combined in various forms and distributed as a stand-alone program product. Finally, it should be noted that additional software components, not shown in this figure, might also be included.

For example, most preferred embodiments of the present invention will include a security and/or encryption mechanism 229 for verifying access to the data and information contained in and transmitted by data server 130. Security mechanism 229 may be incorporated into operating system 221 and/or web server 222. Additionally, security mechanism 229 may also provide encryption capabilities for other components of integrated healthcare management system 100 of FIG. 1, thereby enhancing the robustness of integrated healthcare management system 100. Security mechanism 229 is most preferably configured to protect the integrity and security of the information transmitted via network 120 of FIG. 1. Given the present levels of concern for the protection of personally identifiable information (PII) by laws such as the Health Insurance Portability and Accountability Act (HIPAA) and the Graham-Leach Bliley Act (GLBA), the function of security mechanism 229 is important for compliance issues and to ensure that all PII is adequately protected from inadvertent disclosure and unauthorized access.

Once again, depending on the type and quantity of information stored in database 223 and accessed by indexing mechanism 227, security mechanism 229 may provide different levels of security and/or encryption for different computer systems 170 and 180 of FIG. 1. Additionally, the level and type of security measures applied by security mechanism 229 may be determined by the identity of the end-user and/or the nature of a given request and/or response. In some preferred embodiments of the present invention, security mechanism 229 may be contained in or implemented in conjunction with certain hardware components (not shown this FIG.) such as hardware-based firewalls, switches, dongles, and the like.

Operating system 221 includes the software that is used to operate and control data server 130. In general, processor 210 typically executes operating system 221. Operating system 221 may be a single program or, alternatively, a collection of multiple programs that act in concert to perform the functions of an operating system. Any operating system now known to those skilled in the art or later developed may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate and possibly redundant hardware and software systems. This configuration provides additional robustness for system uptime and reliability purposes. Regardless of the specific form of implementation, Web server 222 provides access, including a user interface, to allow individuals and entities to interact with web portal application 224, including via network 120 of FIG. 1.

Database 223 is representative of any suitable database known to those skilled in the art. In the most preferred embodiments of the present invention, database 223 is a Structured Query Language (SQL) compatible database file capable of storing information relative to various items that may be of interest to the users of integrated healthcare management system 100 of FIG. 1. In the most preferred embodiments of the present invention, database 223 will comprise a collection of information about various patients and their healthcare history as well as providing for the tracking and management of healthcare related assets, procedures and protocols that may be used to provide healthcare services to the patients.

Those skilled in the art will recognize that other types of information for other types of data that may be used in other applications (e.g., historical, informational, technical, etc.) may be stored and retrieved as well. While database 223 is shown to be residing in main memory 220, it should be noted that database 223 may also be physically stored in a location other than main memory 220. For example, database 223 may be stored on external storage device 270 or DASD 280 and coupled to data server 130 via auxiliary storage I/F 240. Additionally, while shown as a single database 223, those skilled in the art will recognize the database 223 may actually comprise a series of related databases, logically linked together. Depending on the specific application and design parameters, database 223 may take many different forms when implemented.

While not required, the most preferred embodiments of data server 130 of FIG. 1 will typically include an email server 224. E-mail server 224 is any email server application capable of being configured and used to send and receive various status messages and updates to data server 130 and between computers 170, 180, and/or 190 of FIG. 1 via email, as may be necessary to enhance the overall process of completing various indexing, search-and-retrieve and/or healthcare transactions described herein. This includes the generation of automated email messages relating to the tracking and management of physical assets as well as informational message related to patient healthcare and the status of integrated healthcare system 100 of FIG. 1. Automated e-mail messages are also generated to provide notifications regarding the status of user accounts as well as treatment, medication, and billing information for healthcare treatment provided to patients in accordance with the preferred embodiments of the present invention.

Optional fax server 225 is any fax server known to those skilled in the art and is configured to receive inbound fax messages and to transmit outbound fax messages. Fax server 225 may format and transmit any data processed by integrated healthcare management system 100 of FIG. 1 and make it available for use by any other component of integrated healthcare management system 100 of FIG. 1. Additionally, fax server 225 may process the data received and send it directly to web server 222 and make the incoming data available for further processing by integrated healthcare management system 100, including asset management mechanism 226, personal health management mechanism 227, and clinical knowledgebase mechanism 228.

Asset management mechanism 226 is a medical asset management solution that helps in location, identification and verification of clinical assets that include a wide spectrum ranging from surgical instruments to capital equipment to the actual drugs themselves. The equipment and other items to be tracked by asset management mechanism 226 are more preferably provided with an RFID tag such as RFID tag 155 or RFID tag 165 of FIG. 1. Prepared with an appropriate RFID tag, RFID reader 125 can continuously monitor the location of each tagged medical asset and store the relevant information for each medical asset in database 223. Asset management mechanism 226 will also be configured to provide a reporting capability for the extracting and formatting of data once the data is extracted from database 223. Additionally, asset management mechanism 226 most preferably comprises one or more user customizable web-based templates that can be utilized to create one or more user interfaces for accessing asset management mechanism 226.

In this fashion, the users of integrated healthcare management system 100 of FIG. 1 can more effectively track and manage the various healthcare assets. This procedure will also allow integrated healthcare management system 100 of FIG. 1 to automatically generate email and or fax messages to be routed to the appropriate managers, user and operators of integrated healthcare management system 100 of FIG. 1, thereby decreasing theft and identifying both high use assets and low use assets. This information can be in budget forecasting, maintenance scheduling and the like.

Similarly, in certain preferred embodiments of the present invention, patients and healthcare workers can be tracked using RFID tags and RFID tag readers. Then, whenever necessary, the movement of the patients and healthcare workers throughout the healthcare facility can be assessed and evaluated to ensure timely patient care and accurate patient routing for responsive treatment and follow-up to ensure that patients have successfully reached the appropriate treatment areas within the healthcare facility.

Personal health management mechanism 227 is an application that physicians, patients and insurance carriers alike can utilize to manage portable personal health records for sick care, preventative care and for managing personal well-being. Examples where portable health records can be made available are the deployment of RFID wristbands and smartcards that relate patients and their health records. RFID readers can access the wristbands and smartcards to extract patient health records at appropriate locations throughout the healthcare facility. Personal health management mechanism 227 most preferably includes a series of pre-formatted style sheets templates that are user-adaptable for rapid and efficient deployment in a wide variety of applications.

Portability and ease of access to patient health information is especially important in responding to accidents and emergencies to enable physician's timely access to patient health records for critical care and to minimize any possible administration of adverse or contra-indicated drugs. In hospitals, approved healthcare providers can identify and access patient health data anytime, anywhere, any place in order to improve care delivery and ensure patient safety from adverse drug reactions. Additionally, portability empowers patients to create and manage wellness and personal health programs by easily accessing and managing their own general health data. Personal health management mechanism 227 will also be configured to provide a reporting capability for the extracting and formatting of data once the data is extracted from database 223. Additionally, personal health management mechanism 227 most preferably comprises one or more user customizable web-based templates that can be utilized to create one or more user interfaces for accessing personal health management mechanism 227.

Clinical knowledgebase 228 is a clinical information knowledgebase that contains an exhaustive collection of clinical information for managing personal health and disease to deliver high quality health care efficiently. Clinical knowledgebase 228 can be implemented in a number of ways but will typically comprise a database application that is capable of storing and retrieving various types of data related to the diagnosis and treatment of various injuries and diseases. Clinical information spanning several multi-disciplinary practice areas are made available to the rules engine and work flow model in integrated healthcare management system 100 of FIG. 1 to analyze and assist in the diagnosis and treatment of a given disease and personal health management. Clinical knowledgebase 228 will also be configured to provide a reporting capability for the extracting and formatting of data once the data is extracted from database 223.

Today, “best practices” or best known methods for disease management that are vertical in nature, such as diabetes, exist as a proven model and can be captured in clinical knowledgebase 228. As a starting point, clinical knowledgebase 228 provides an innovative secure clinical information knowledgebase to enable a standard disease management model by relating clinical information and patient data to the best-known treatment methodologies that are available at the time of diagnosis and treatment. In addition to the data storage aspect of clinical knowledgebase 228, a rules engine and workflow model will be included to assist in the management of the knowledgebase. In certain preferred embodiments of the present invention, it is possible that clinical knowledgebase 228 may be integrated with database 223.

In the most preferred embodiments of the present invention, the various components of integrated healthcare management system 100 of FIG. 1 are able to communicate using an enhanced version of the eXtended Markup Language (XML). This enhanced version of XML is adapted and configured to allow for the rapid and efficient transmission and receipt of data by and between the various components of integrated healthcare management system 100 of FIG. 1. The extended version of the XML language described herein includes an engine for executing commands and implementing routines, processes, and procedures, and for using expanded syntax for processing healthcare related data. The use of XML in general is well known to those skilled in the art and the enhanced version of XML described herein, “ehealthXML,” is a unique adaptation with specialized syntax that allows for the “tagging” of data elements with healthcare-specific information, thereby facilitating the rapid and effective exchange of healthcare-related data with multiple disparate systems and communication protocols. Additional information about ehealthXML is presented below.

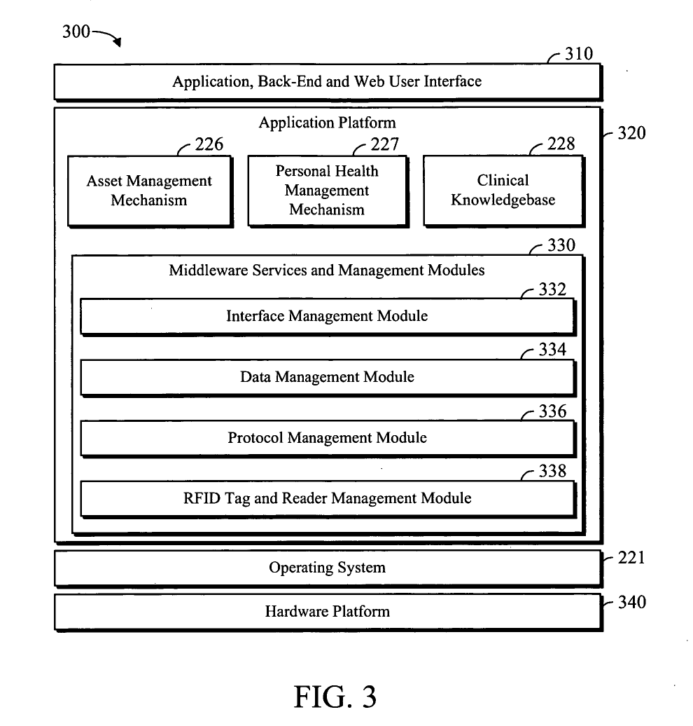

Referring now to FIG. 3, a block diagram of an architectural structure 300 for deploying an integrated healthcare management system 100 of FIG. 1 in accordance with a preferred embodiment of the present invention is depicted. As shown in FIG. 3, integrated healthcare management system 100 of FIG. 1 comprises: a hardware platform 340; an operating system 221; an application platform 320; a series of middleware services and management modules 330, and an application, back-end, and web user interface 310.

Architectural structure 300 not only provides a modular platform for implementing integrated healthcare management system 100 of FIG. 1, but also provides a platform suitable for building additional modules and/or software applications and provides an extensible framework for enhancing integrated healthcare management system 100 of FIG. 1 in the future. By providing a plurality of middleware services and management modules 330, integrated healthcare management system 100 of FIG. 1 may be upgraded and improved as necessary and or desired to offer additional capabilities.

Middleware services and management modules 330 are a collection of software applications, libraries, or routines that function as “building blocks” for creating higher level software applications or mechanisms that assist in the overall operation and interaction of the various components of integrated healthcare management system 100 of FIG. 1. For example, interface management module 332 is configured to receive and handle communications with a wide variety of software platform and data management module 334 is configured to manage data input, data storage, data manipulation, and data output for integrated healthcare management system 100 of FIG. 1. In like fashion, protocol management module 336 is configured to handle the various types of communication signals that may be received by integrated healthcare management system 100 of FIG. 1.

Similarly, RFID tag and reader management module 338 is a component that is specifically designed to handle and route the RFID data collected and transmitted by RFID tags such as RFID tags 155 and 165 of FIG. 1 and RFID reader 125 of FIG. 1. RFID tag and reader management module 338 is configured to interpret the RFID tag information and coordinate the storage and retrieval of the RFID data with database 223 via asset management mechanism 226 of FIG. 2. In this fashion, the RFID data can be utilized by asset management mechanism 226 in order to track the status, location, and usage patterns for physical equipment used in conjunction with integrated healthcare management system 100 of FIG. 1.

RFID tag and reader management module 338 will most preferably be configured to work in conjunction with Data management module 334 to provide algorithms and mechanisms for compression of 64-bit and 96-bit RFID tag data for communication using an enhanced version of the XML language as described above in conjunction with asset management mechanism 226, personal health management mechanism 227, and clinical knowledgebase 228. This will allow enhanced data transmission speeds and reduce data congestion on network 120 of FIG. 1. Additional information about middleware services and management modules 330 is presented below.

Hardware platform 340 is representative of the hardware used to deploy and operate integrated healthcare management system 100 of FIG. 1 and includes the various components previously described in conjunction with FIG. 1 and FIG. 2. Application, back-end, and web user interface 310 are representative of the software applications used to access the functionality of integrated healthcare management system 100 of FIG. 1. Additionally, application, back-end, and web user interface 310 most preferably comprises one or more user customizable web-based templates that can be utilized to create one or more user interfaces for accessing integrated healthcare management system 100 of FIG. 1. This includes the creation and implementation of billing and other back-office related functions. By accessing application, back-end, and web user interface 310, the user of integrated healthcare management system 100 of FIG. 1 can insert, retrieve, update, sort, and review the various information stored in and made available by integrated healthcare management system 100 of FIG. 1. This information may be provided in virtually any form desired and requested by the users such as reports, graphs, charts, etc.

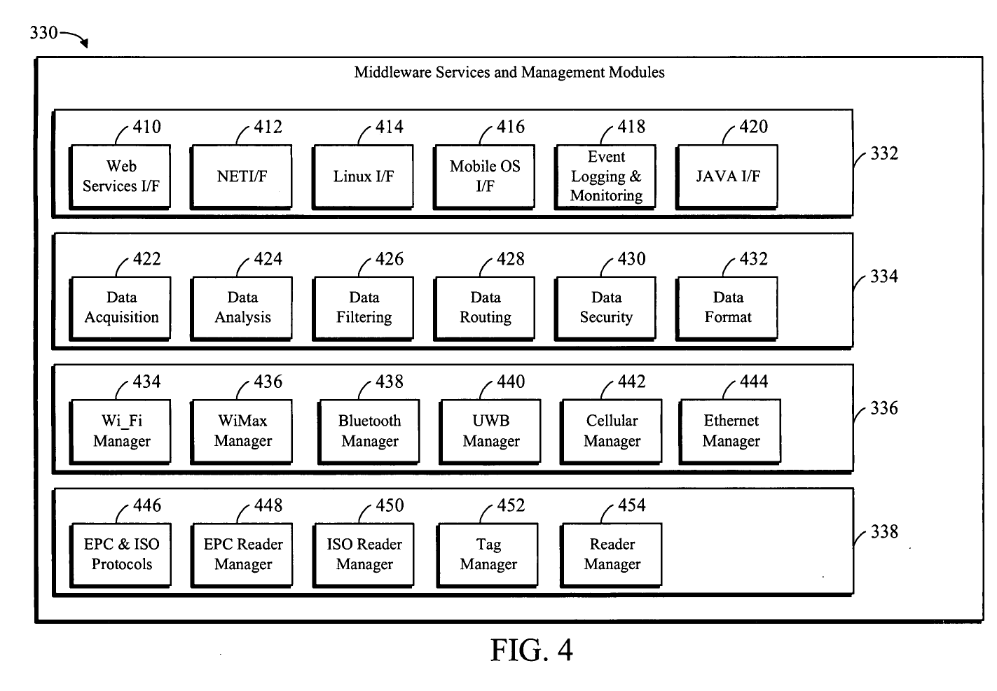

Referring now to FIG. 4, additional information about middleware services and management modules 330 of FIG. 3 are shown. Each of middleware services and management modules 330 are configured to accomplish specific tasks and to provide support for the various needs of the higher level software applications and mechanisms that comprise integrated healthcare management system 100 of FIG. 1. By accessing the functionality and capabilities of middleware services and management modules 330, integrated healthcare management system 100 of FIG. 1 can accomplish the various tasks necessary to provide the users with a robust and functional system for providing efficient and effective healthcare.

As shown in FIG. 4, interface management module 332 comprises: a web services I/F component 410; a .net I/F component 412; a Linux I/F component 414; a mobile OS I/F component 416; an event logging and monitoring component 418; and a JAVA I/F component 420. Data management module 334 comprises: a data acquisition component 422; a data analysis component 424; a data filtering component 426; a data routing component 428; a data security component 430; and a data format component 432. Protocol Management module 336 comprises: a wi-fi manager component 434; a wi/max manager component 436; a Bluetooth manager 438; a UWB manager 440; a cellular manager 442; and an Ethernet manager 444. RFID tag and reader management module 338 comprises: a EPC and ISO protocol component 446; a EPC reader/manager component 448; an ISO reader/manager component 450; a tag manager component 452 and a reader manager component 454.

Referring now to FIG. 1, FIG. 2, FIG. 3, and FIG. 4, basic process flow for integrated healthcare management system 100 of FIG. 1 is described. In the most preferred embodiments of the present invention, the user will access integrated healthcare management system 100 of FIG. 1 via a standard web browser such as Microsoft Internet Explorer, Netscape Navigator, Mozilla Firefox, Safari, or the like. The web browser can be operated by any standard methodology such as using desktop computer 170, laptop computer 180, or PDA 190 of FIG. 1. The user can use the web browser to access application platform 320 and the associated software mechanisms, asset management mechanism 226, personal health management mechanism 227, and clinical knowledgebase 228. The various software mechanisms shown in FIG. 2 and FIG. 3 are used by various users to input data into and retrieve data such as reports and the like from database 223 of FIG. 1.

For example, whenever a doctor has an appointment with a new patient, the doctor or the doctor's office staff can utilize a web browser to access web user interface 310 to input data about the new patient via personal health management mechanism 227 and this data will be stored in database 223 of FIG. 1. Similarly, whenever the doctor needs to research various possible diagnoses and/or treatment methodologies, the doctor can access clinical knowledgebase 228 via the web browser to retrieve the desired information. The information from clinical knowledgebase 228 can be integrated with the data contained in the patient's health history as identified by the relevant patient record, thereby creating a continually updated health record for access by the patient and his or her authorized agents. Data management module 334 will provide the data services necessary to retrieve, format, and display the desired information.

Similarly, whenever information about a physical asset is desired or required, web user interface 310 can be used to access asset management mechanism 226 of FIG. 2. By selecting the appropriate queries, information such as the status of the physical asset, the location of the physical asset, and the usage pattern for the physical asset can be retrieved and viewed. Additional information about the physical assets can be stored, thereby creating a complete historical record for the medical equipment from the time of acquisition until the time of ultimate disposal.

In the most preferred embodiments of the present invention, ehealthXML enables the creation and maintenance of a plethora of clinical information such as medical equipment, type, category, supplier, medicine and controlled drugs, personal health information, health records, etc. in a machine interoperable format. ehealthXML binds specific information that can be tagged in an ehealthXML electronic document to a person, object or record to create a matrix of related, event, context specific clinical information knowledgebase. Further, ehealthXML delivers information to computer systems in a format (ASCII, XML, JAVA, etc.) that can be understood by the target system. The tagging of specific fields in a document or database record hardens sensitive and/or critical data for security and privacy purposes as well as providing a means for developing a rich but simple implementation of ontologys to share healthcare-related information.

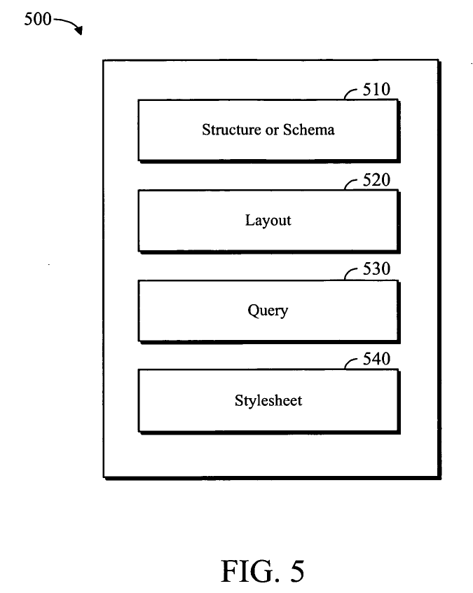

Referring now to FIG. 5, a block diagram for the implementation of ehealthXML is depicted. For most known systems, clinical information is stored in relatively isolated “data silos,” in a variety of data formats that are either standard, proprietary and/or a combination of the two, and spread across the globe where heterogeneous machines and humans have multiple interoperability challenges associated with deciphering and making sense of the clinical information for proper processing and presentation of the information when desired. In order to address the need for more efficient and effective data-sharing operations, ehealthXML has been developed for use in conjunction with integrated healthcare management system 100 of FIG. 1.

As shown in FIG. 5, the most preferred embodiments of ehealthXML include a structure and schema component 510, a layout component 520, a query component 530, and a stylesheet component 540.

Structure and schema component 510 represents a methodology used to tag and organize clinical information in a secure, related manner in an electronic document to create the base ontology or specification of a conceptualization for the data to be stored and transmitted. Additional information about structure and schema component 510 is presented below.

Layout component 520 represents a hardware or machine level presentation of the healthcare information based on indexing and referencing a matrix of clinical information from the base ontology set forth by structure and schema component 510.

Query component 530 represents an application level layer that provides an abstraction to input ehealthXML syntax queries for information retrieval by the user of integrated healthcare management system 100 of FIG. 1.

Stylesheet component 540 represents a user level presentation of the various results derived and presented in conjunction with the data extracted by Query component 530.

A sample data table, shown below, could be used in indexing the personal health record created in the Clinical Knowledgebase 228 of FIG. 1. In this case, the record pertains to the medication and treatment provided for a given patient.

| Medication and Treatment Record | |
|---|---|
| Create ehealthXML Table MedicationTreatmentRecord | |
| ( | |
| AdmissionID | Decimal(10), |
| RecordDate | Datetime, |
| Shift | Varchar(35) Default ”, |
| NurseID | Decimal(10), |
| Drug | Varchar(35) Default ”, |
| Dose | Varchar(35) Default ”, |
| DoctorID | Decimal(10), |
| Indication | Varchar(35) Default ”, |
| Primary Key | (AdmissionID,RecordDate,Drug) |
| ) | |

A sample query in the ehealthXML language is shown below. This and other similar queries can function as in a relational database table to look up any row and column in the database as well as use various path expressions to traverse many related nodes in an ehealthXML document. The following example describes path expressions.

```
<?xml version=“1.0”?>
<ehealthXMLphrecord id=“12345678910”>
    <random>
      <rid>12345678910</rid>
    </random>
</ehealthXMLphrecord>
```

The following example ehealthXML function cal “doc( )” can be invoked to return a desired ehealthXML personal health record from a absolute URL. This allows for the use of the ehealthXML language in a system that stores and retrieves medical records and related information over a local area network or wide area network, including the Internet.

doc(“https://www.aventyn.com/clip/xml/ehealthXMLphrecord.xml”)

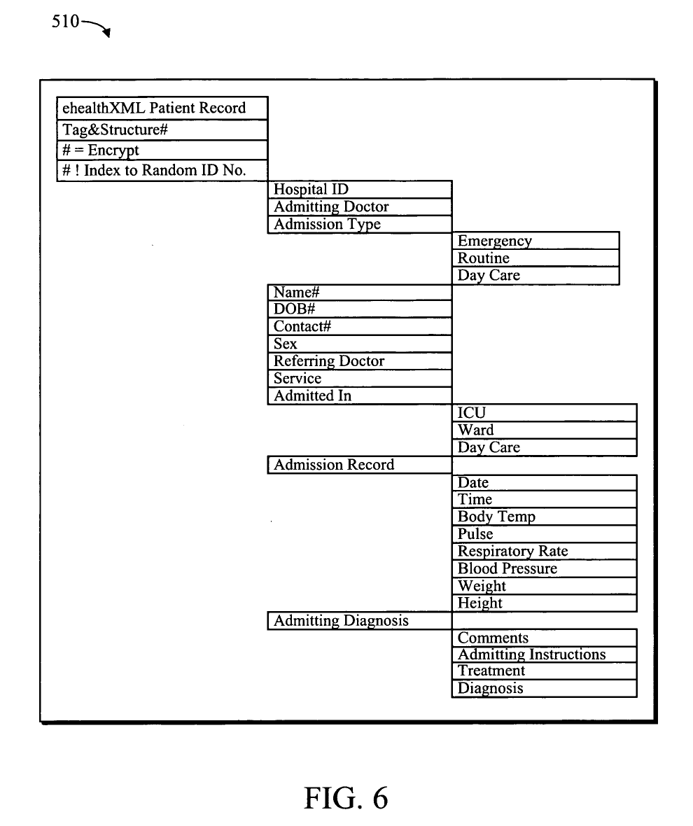

Referring now to FIG. 6, a sample structure and schema component 510 is depicted. In this example, the “&” character indicates a data fields in a structure that will be tagged and “#” character indicates one or more data fields that will be encrypted and/or used to replace personal information with a random identification number, thereby enhancing the security of the information stored in those fields. Those skilled in the art will recognize that this is only a single possible implementation and that other, related implementations may be deployed based on the specific application.

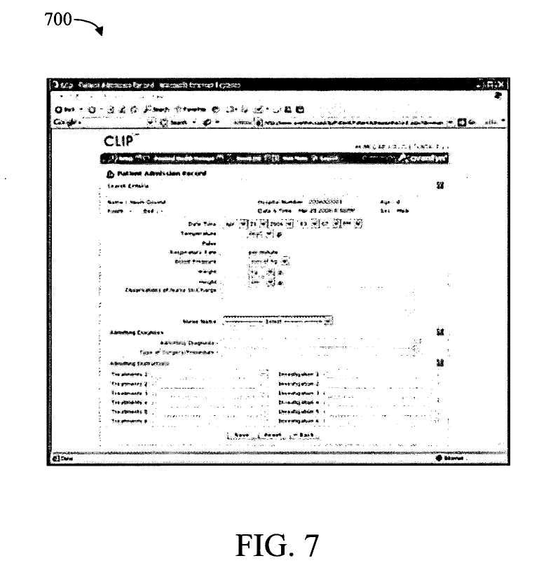

Referring now to FIG. 7, a sample user interface 700 for viewing ehealthXML managed health records is depicted. As shown in FIG. 7, various data elements stored in database 223 of FIG. 1 can be retrieved, formatted, and presented for review to a user of integrated healthcare management system 100 of FIG. 1. Since the user interface is a web browser, any standard computer capable of utilizing a web browser may be utilized to access the information stored in database 223 of FIG. 1.

By deploying a standardized XML language as set forth herein, significant benefits can be obtained. Specifically, hospitals, medical labs, and medical device manufacturers can benefit from the more accurate and timely tracking of data related to equipment, inventory, and patients. For example, medical lab tests as well as the data and device information used to administer, collect, and route clinical information can be more effectively and efficiently deployed to benefit hospitals and health care providers, insurers, employers, government organizations and ultimately the patients themselves who are the consumers of healthcare services.

Most importantly, the ehealthXML language can measurably improve the pace of drug discovery and development by enabling pharmaceutical manufacturers a low cost and simple way to access virtual related, interoperable clinical information from a variety of sources in a standardized format. This will allow for new and improved data sharing where the data gathering process crosses gender, region, symptoms, diseases, medical history, etc without subjecting humans to clinical trials at the risk of debilitating human (non-human) health, safety and the huge amount of capital and human resource that is sunk into these efforts today.

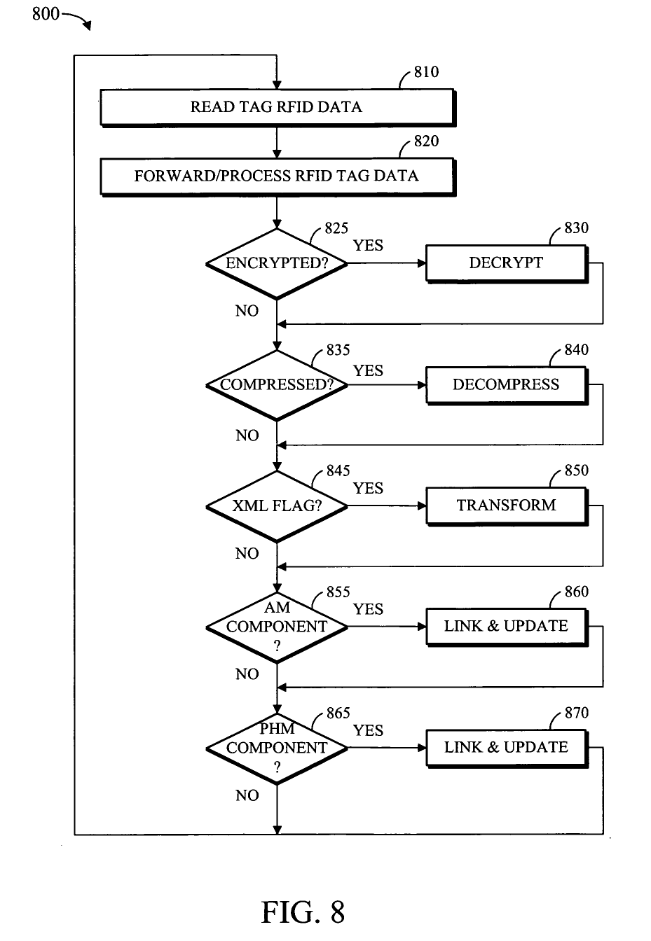

Referring now to FIG. 8, a flow chart for a method 800 of using RFID tags in an integrated healthcare management system in accordance with a preferred exemplary embodiment of the present invention is depicted. As shown in FIG. 8, the overall process involves the constant reading of RFID data from one or more RFID tags (step 810). This RFID data is forwarded and processed by integrated healthcare management system 100 of FIG. 1 (step 820) to accomplish the objectives of the preferred embodiments of the present invention. Basically, one or more RFID tag readers will constantly monitor the facility and the people and equipment associated with the healthcare facility. The movement of people and/or equipment in the vicinity of the RFID tag readers will trigger an “alert” or signal that will be interpreted and used to interact with the other components of integrated healthcare management system 100 of FIG. 1.

For example, once the RFID data has been forwarded, it will be examined to determine whether or not the RFID data is encrypted (step 825). If the RFID data is encrypted (step 825=“YES”), then a security mechanism such as security mechanism 229 of FIG. 2 will be used to decrypt the data (step 830) and make the RFID data available for further processing. While not all RFID data transmissions need to be encrypted, certain types of information, such as sensitive medical information and personally identifiable information associated with patients, etc., will typically be encrypted to ensure the safety and integrity of the data.

If the data is not encrypted (step 825=“NO”) or after the data has been decrypted, then method 800 will proceed and the RFID data will be examined to determine whether or not the data is compressed (step 835). If the RFID data is compressed (step 835=“YES”), then the RFID data will be decompressed and made available for further processing (step 840).

If the RFID data is not compressed (step 835=“NO”) or after the data has been decompressed, then method 800 will continue and the RFID data will be examined to determine whether or not the data contains an XML flag, indicating that the RFID data should be transformed to ehealthXML (step 845). If the XML flag is set (step 845=“YES”), then the RFID data will be transformed to ehealthXML (step 850) and the ehealthXML data will be stored and made available for further processing. Once the data has been decrypted, decompressed, and converted to ehealthXML as necessary, the data can be identified with one or more applications.

Once the RFID data has been captured and converted as necessary, method 800 continues by examining the data to determine if the data contains values for the Asset Management (AM) component of integrated healthcare management system 100 of FIG. 1 (step 855). If the RFID data is related to the AM component (step 855=“YES”), then the RFID data will be used to retrieve the appropriate AM record from the database and the data will be linked to that portion of the database and the database will be updated (step 860). Otherwise (step 855=“NO”), the transmitted RFID data will be examined to determine if the data contains values for the Personal Health Management (PHM) component of integrated healthcare management system 100 of FIG. 1 (step 865). If the RFID data is related to the PHM component (step 865=“YES”), then the RFID data will be used to retrieve the appropriate PHM record from the database and the data will be linked to that portion of the database and the database will be updated (step 870). As shown in FIG. 8, this process will repeat continually, with RFID data being transmitted and integrated into integrated healthcare management system 100 of FIG. 1 and being made available to the authorized users of integrated healthcare management system 100 of FIG. 1.

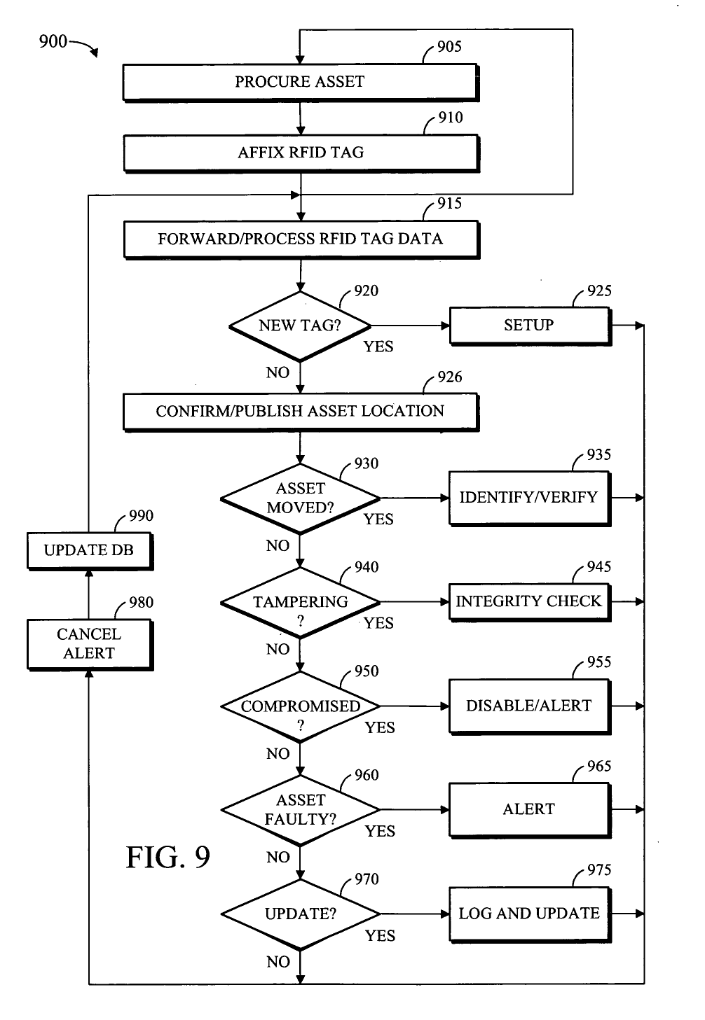

Referring now to FIG. 9, a flow chart for a method 900 of using RFID tags to manage assets in an integrated healthcare management system in accordance with a preferred exemplary embodiment of the present invention. As shown in FIG. 9, whenever a new asset is purchased for the healthcare facility (step 905), then an RFID tag will be associated with the asset and the RFID tag will be affixed to the newly acquired asset (step 910). Note that this process may be completed as often as new assets are acquired.

As explained in conjunction with FIG. 8, once the RFID data is made available after acquisition by an RFID tag reader, the RFID data is forwarded and processed by integrated healthcare management system 100 of FIG. 1 (step 915) to accomplish the objectives of the preferred embodiments of the present invention. The RFID data is continuously monitored by the RFID readers and data is transmitted from the RFID tags for further processing by integrated healthcare management system 100 of FIG. 1. Typically, the data is updated whenever an asset is moved into range of an RFID reader or when the asset is operated.

Once the RFID data is received, the data will be examined to determine if the asset associated with the RFID tag is a newly acquired asset (step 920). If the asset associated with the RFID data reflects the acquisition of a new asset (step 920=“YES”), then the new asset information will be configured in the database (step 925). If the asset associated with the RFID data does not reflect the acquisition of a new asset (step 920=“NO”), then the RFID data will typically be used to confirm and publish the physical location of the asset associated with the RFID data (step 926).

Once the present location has been established, it can be compared to the previous location of the asset associated with the RFID data to determine whether or not the asset has been moved (step 930). If the asset has been moved from the previous location (step 930=“YES”), the present location will be identified and verified (step 935) to determine if the asset has been or is being moved to an inappropriate or restricted area. As part of this process, an alarm or alert can be activated to alert the appropriate person or persons as to the improper movement or location of the asset. This notification can take place via instant message, email, SMS message to a cell phone, preprogrammed phone call, etc.

Next, the RFID data can be examined to determine if the RFID tag has been tampered with (step 940). In this case, if the RFID has been tampered with, then an integrity check can be performed to determine the problem with the RFID tag. If tampering is not detected (step 940=“NO”), then method 900 will continue to process the RFID data to determine if the RFID tag has been compromised (step 950). If the RFID tag has been compromised (step 950=“YES”), then the RFID tag will be disabled and an alert will be sent to the operators of integrated healthcare management system 100 of FIG. 1. This notification can take place via instant message, email, SMS message to a cell phone, preprogrammed phone call, etc.

If the RFID tag has not been compromised, then method 900 will continue to determine whether or not the asset is faulty and/or whether any routine maintenance has been scheduled for the asset (step 960). As previously explained, if the asset is faulty or if scheduled maintenance is due (step 960=“YES”), then an alert will be sent to the operators of integrated healthcare management system 100 of FIG. 1. This notification can take place via instant message, email, SMS message to a cell phone, preprogrammed phone call, etc.

Finally, after other considerations have been made, the appropriate and authorized use of the asset can be noted and updated (step 970). If the asset is simply being used as intended (step 970=“YES”), the usage details (time, place, duration, etc.) can be noted then logged and updated in the appropriate database record (step 975).

After processing the RFID data as shown in method 900, the various alerts can be cancelled (step 980) and any required database updates can be made (step 990). As shown in FIG. 9, method 900 continually processes the RFID data and makes it available to the operators and users of integrated healthcare management system 100 of FIG. 1.

It should also be noted that at any time, if a general system failure is noticed (i.e., multiple RFID tag readers become inoperative, multiple tampering events are detected, etc.), then a system-wide alert may be generated to allow for prompt notification and to initiate appropriate intervention by the operators of integrated healthcare management system 100 of FIG. 1. This notification can take place via instant message, email, SMS message to a cell phone, preprogrammed phone call, etc. If such a failure takes place, then the RAM image of the RFID data can be stored in a non-volatile memory to assist in back-up and retrieval or any recovery process.

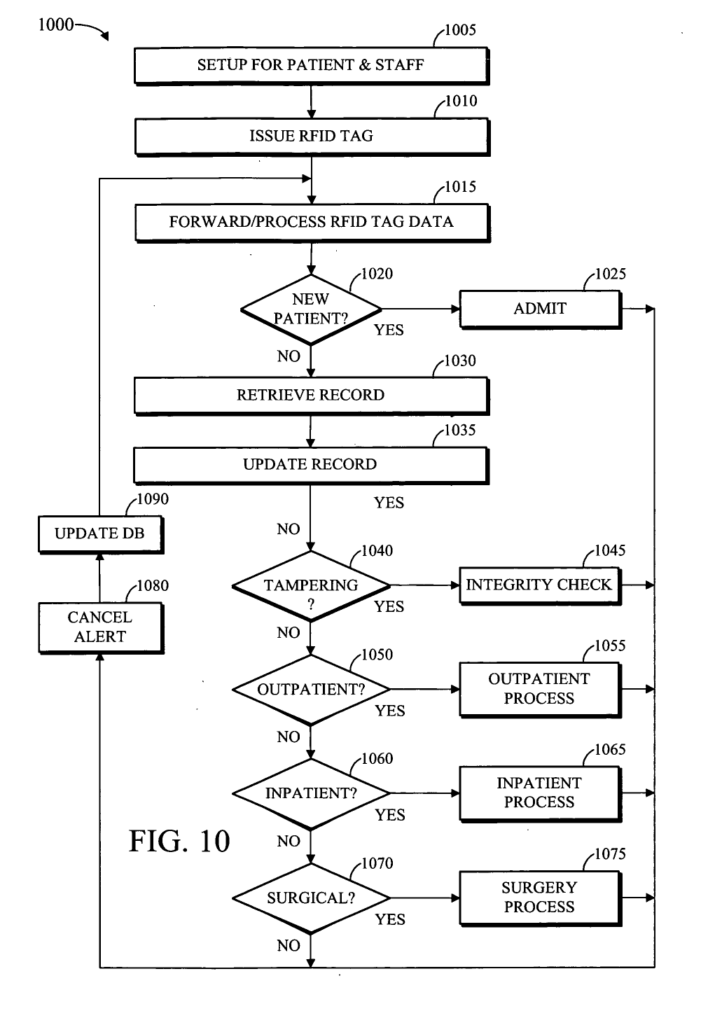

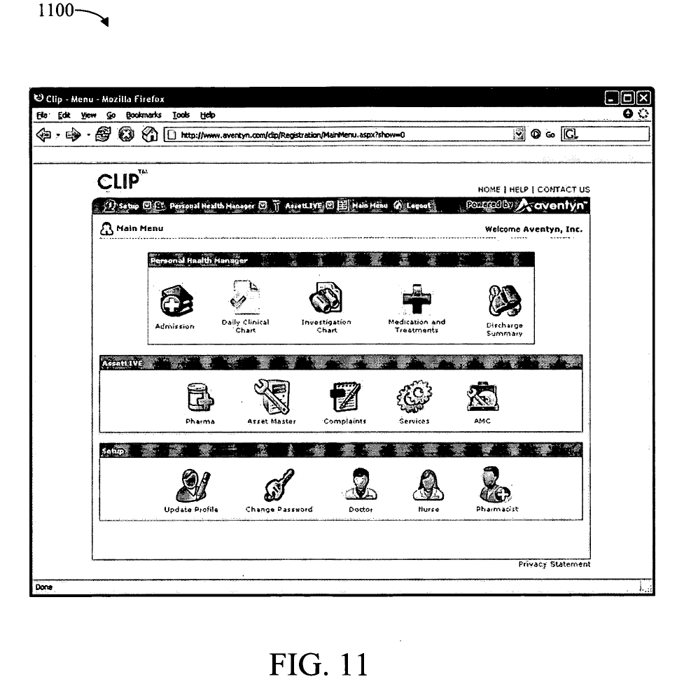

Referring now to FIG. 10, a flow chart for a method 1000 of using RFID tags to manage patient-related healthcare records in an integrated healthcare management system in accordance with a preferred exemplary embodiment of the present invention. As shown in FIG. 10, each whenever a new patient or staff member is to be allowed access to a healthcare facility, then part of the administrative process will include setting them up in integrated healthcare management system 100 of FIG. 1 (step 1005), and an RFID tag will be associated with and attached to the patient or staff member (step 1010). The RFID tag may be a passive or active tag and may be affixed as a wrist band, hang tag, wallet card, key fob, etc. Note that this process may be completed as often as new patients or staff members are admitted.

As explained in conjunction with FIG. 8, once the RFID data is made available after acquisition by an RFID tag reader, the RFID data is forwarded and processed by integrated healthcare management system 100 of FIG. 1 (step 1015) to accomplish the objectives of the preferred embodiments of the present invention. The RFID data is continuously monitored by the RFID readers and data is transmitted from the RFID tags for further processing by integrated healthcare management system 100 of FIG. 1. Typically, the data is updated whenever a patient or staff member is moved into range of an RFID reader or when the asset is operated.

Once the RFID data is received, the data will be examined to determine if the asset associated with the RFID tag is a new patient (step 1020). If the patient associated with the RFID data reflects a new patient (step 1020=“YES”), then the new patient will admitted. This includes the preparation of the usual forms (health insurance, drug interactions, HIPAA consent forms, etc.) and this information will be configured in the database (step 1025). If the patient associated with the RFID data does not a new patient (step 1020=“NO”), then the RFID data will typically be used to retrieve the patient's health records (step 1030). Once the patient's record has been retrieved, it can be updated (step 1030).

Next, the RFID data can be examined to determine if the RFID tag has been tampered with (step 1040). In this case, if the RFID has been tampered with, then an integrity check can be performed to determine the problem with the RFID tag. If tampering is not detected (step 1040=“NO”), then method 1000 will continue to process the RFID data to determine if the patient is an outpatient (step 1050). If the patient is an outpatient (step 1050=“YES”), then the appropriate entries can be made in their record (i.e., medication and treatment processing, billing, diagnosis, discharge summary, etc.) (step 1055).

Then method 1000 will continue to process the RFID data to determine if the patient is an inpatient (step 1060). If the patient is an inpatient (step 1060=“YES”), then the appropriate entries can be made in their record (i.e., room assignment, daily log entries, medication and treatment processing, billing, diagnosis, etc.) (step 1065).

Then method 1000 will continue to process the RFID data to determine if the patient is a surgical patient (step 1070). If the patient is an inpatient (step 1070=“YES”), then the appropriate entries can be made in their record (i.e., consent forms for surgeries, pre-op room assignment, recovery room assignment, daily log entries, medication and treatment processing, billing, diagnosis, etc.) (step 1075).

Those skilled in the art will understand that the various processes described herein are examples only and other similar processes can be developed for other situations that typically arise in a healthcare environment.

After processing the RFID data as shown in method 1000, the various alerts can be cancelled (step 1080) and any required database updates can be made (step 1090). As shown in FIG. 10, method 1000 continually processes the RFID data and makes it available to the operators and users of integrated healthcare management system 100 of FIG. 1.

It should also be noted that at any time, if a general system failure is noticed (i.e., multiple RFID tag readers become inoperative, multiple tampering events are detected, etc.), then a system-wide alert may be generated to allow for prompt notification and to initiate appropriate intervention by the operators of integrated healthcare management system 100 of FIG. 1. This notification can take place via instant message, email, SMS message to a cell phone, preprogrammed phone call, etc. If such a failure takes place, then the RAM image of the RFID data can be stored in a non-volatile memory to assist in back-up and retrieval or any recovery process.

Referring now to FIG. 11, a sample user interface 1100 for accessing an integrated healthcare management system 100 of FIG. 1 in accordance with a preferred embodiment of the present invention is shown. As shown in FIG. 11, a user of integrated healthcare management system 100 of FIG. 1 can access the Asset Location, Identification and Verification component of the system to identify, locate, verify and track various assets in the healthcare industry which include medical instruments, drugs and capital assets such as EKG/ECG equipment. The Personal Health Manager component can also be accessed to offer static and dynamic capture and presentation of personal health information management, medication administration, treatment management and wellness applications. The Clinical Knowledgebase component works in the background to track and store the information and data necessary for the successful operation of integrated healthcare management system 100 of FIG. 1, including storing and retrieving information in and from one or more databases.

In summary, the present invention provides a modular standards-based platform built on an innovative modular architectural framework that specifically addresses the needs of the healthcare industry. The most preferred embodiments of the present invention benefits Healthcare Providers, Medical Device Manufacturers and Healthcare System Integrators with a lower cost, high performance RFID healthcare information processing solution that is interoperable, secure, highly available, real time and scalable. Those skilled in the art will also recognize that while the preferred exemplary embodiments of the present invention have been explained in terms of treatment for human patients the present invention can be deployed in a veterinarian practice and that the methods are equally applicable to non-human patients (e.g., dogs, pets, horses, etc.).

The Asset Location, Identification and Verification component benefits include the ability to identify, locate, verify and track various assets in the healthcare industry which include medical instruments, drugs and capital assets such as EKG/ECG equipment. The Personal Health Manager component benefits healthcare providers and patients through static and dynamic capture and presentation of personal health information management, medication administration, treatment management and wellness applications. The Clinical Information Knowledgebase component benefits physicians, patients, payers and providers with the potential for disease management and multi-disciplinary clinical information routing.

Interoperable clinical information exchange has the potential to improve the drug discovery and development process, reduce insurance costs and improve business process, workflow and decision-making. Overall, the integrated healthcare management system of the present invention complements and enhances healthcare delivery by providing a standards based clinical information processing platform that ensures delivery of efficient, high quality healthcare. Those skilled in the art will recognize that, in addition to RFID technology, other similar or related wireless communication technologies such as Near Field Communication (NFC) technology, wireless motes/relays technology, and Micro-Electro-Mechanical Systems (MEMS) technology, as well as other types of wireless sensors and related devices may also be employed in various preferred embodiments of the present invention.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

1. An apparatus comprising:
a processor;
a memory coupled to said processor;
at least one RFID tag;
at least one RFID tag reader, said at least one RFID tag reader being configured to communicate with said at least one RFID tag;
an asset management mechanism residing in said memory, said asset management mechanism being configured to communicate with said at least one RFID tag reader to track at least one asset;
a personal health management mechanism residing in said memory, said asset management mechanism being configured to communicate with at least one RFID tag reader to track at least one person; and
a clinical knowledgebase residing in said memory, said clinical knowledgebase being configured to store and retrieve data relative to said at least one asset and said at least one patient.

2. The apparatus of claim 1 wherein said at least one RFID tag comprises a plurality of RFID tags and said at least one RFID tag reader comprises a plurality of RFID tag readers.

3. The apparatus of claim 1 further comprising:
an XML-based language residing in said memory, said XML-based language being configured to interact with said asset management mechanism and said personal health management mechanism, and said clinical knowledgebase, thereby providing for the transmission of clinical information and data relative to said at least one asset and said at least one person; and
at least one application programming interface (API) residing in said memory, said at least one API being configured to provide for clinical asset tracking, electronic health record management and data interactivity with said clinical knowledgebase.

4. The apparatus of claim 1 further comprising a network coupled to said memory, said network being connected to a computer system, said network comprising at least one wireless communication device.

5. The apparatus of claim 1 further comprising a network coupled to said memory, said network being connected to a computer system, said network comprising at least one wireless communication device.

6. The apparatus of claim 1 further comprising a security mechanism residing in said memory, said security mechanism providing encryption capabilities for said data.

7. The apparatus of claim 1 further comprising:
a plurality of assets in a medical facility, each of said plurality of assets bearing an RFID tag;
a plurality of persons in a medical facility, each of said plurality of persons bearing an RFID tag;
an application residing in said memory, said application being configured to provide a user interface for tracking, locating and reporting the physical location of said plurality of assets and said plurality of persons; and
said application being configured to interoperate with said asset management mechanism and said personal health management mechanism and said clinical knowledgebase, thereby providing an integrated health management system.

8. The apparatus of claim 1 wherein said asset management mechanism, said personal health management mechanism, and said clinical knowledgebase comprise an application platform, said application platform further comprising:
an interface management module;
a data management module;
a protocol management module; and
an RFID tag and reader management module.

9. The apparatus of claim 8 wherein:
said interface management module comprises at least one of:
a web services interface;
a network interface;
a Linux interface;
a mobile operating system interface;
an event logging and monitoring interface; and
a JAVA interface;
said data management module comprises at least one of:
a data acquisition module;
a data analysis module;
a data filtering module;
a data routing module;
a data security module; and
a data format module;
said protocol management module comprises at least one of:
a WiFi manager;
a WiMax manager;
a Bluetooth manager;
a UWB manager;
a cellular manager;
an Ethernet manager; and
said RFID tag and reader management module comprises at least one of:
an EPC & ISO protocol manager;
an EPC reader manager;
an ISO reader manager;
a tag manager; and
a reader manager.

10. A method comprising the steps of:
a) reading an RFID tag to extract RFID data;
b) decrypting said RFID data if said RFID data has been previously encrypted;
c) decompressing said RFID data if said RFID data has been previously compressed;
d) transforming said RFID data to an XML stream if said RFID data has been previously tagged as XML data; and
e) linking said RFID data to an appropriate data storage location based on the content of the RFID data.

11. The method of claim 10 wherein said step of linking said RFID data to an appropriate data storage location based on the content of the RFID data comprises the step of storing said RFID data in a clinical knowledgebase.

12. The method of claim 10 wherein said step of linking said RFID data to an appropriate data storage location based on the content of the RFID data comprises the steps of:
using said RFID data to identify a specific asset or a specific person;
tracking, analyzing and reporting the location of said specific asset or said specific person using said RFID data.

13. The method of claim 10 wherein said asset is one of a medical device and a controlled substance.

14. The method of claim 10 wherein said person is one of a doctor, a nurse, an administrator, a staff member, and a patient in a medical facility.

15. The method of claim 10 further comprising the steps of:
using said RFID data to identify a physical location for said asset or person; and
generating an alert if said physical location for said asset or person is outside a per-determined boundary for said asset or person.

16. The method of claim 10 further comprising the step of providing a web-based user interface to allow a user to access said RFID tag data and use said RFID tag data to implement an integrated healthcare management system.

17. A program product comprising:
an asset management mechanism, said asset management mechanism being configured to communicate with at least one RFID tag reader to track at least one asset;
a personal health management mechanism, said asset management mechanism being configured to communicate with at least one RFID tag reader to track at least one patient;
a clinical knowledgebase, said clinical knowledgebase being configured to store and retrieve data relative to said at least one asset and said at least one patient; and
signal bearing media bearing said asset management mechanism and said personal health management mechanism and said clinical knowledgebase.

18. The program product of claim 17 further comprising:
an XML-based language configured to interact with said asset management mechanism and said personal health management mechanism and said clinical knowledgebase, thereby providing for the transmission of clinical information and data relative to said at least one asset and said at least one patient; and
at least one application programming interface (API), said at least one API being configured to provide for clinical asset tracking, electronic health record management and data interactivity with said clinical knowledgebase.

19. The program product of claim 17 wherein said signal bearing media comprises recordable media.

20. The program product of claim 17 wherein said signal bearing media comprises transmission media.
